(19) United States
(12) Patent Application Publication
(10) Pub. No.: US 2010/0182711 A1
(43) Pub. Date: Jul. 22, 2010

(54) Substrate for a mirror support made of glass or glass ceramic

(75) Inventors: Thomas Westerhoff, Mainz (DE); Martin Schaefer, Mainz-Kostheim (DE); Peter Thomas, Koblenz (DE); Ralf Reiter, Mainz-Kastel (DE); Volker Seibert, Hochheim (DE)

Correspondence Address: OHLANDT, GREELEY, RUGGIERO & PERLE, LLP, ONE LANDMARK SQUARE, 10TH FLOOR, STAMFORD, CT, 06901, US

(73) Assignee: SCHOTT AG.

(21) Appl. No.: 12/657,314

(22) Filed: Jan. 19, 2010

(30) Foreign Application Priority Data
Jan. 19, 2009 (DE) 102009005400.6-51

(51) Int. Cl. G02B 5/08; B32B 3/30; B32B 3/10; B32B 3/12; B32B 3/02; B32B 38/10

(52) U.S. Cl. 359/883; 428/172; 428/138; 428/116; 428/64.1; 156/250

(57) ABSTRACT

A substrate and methods of making is provided. The substrate is made of glass or glass ceramic and finds use as a mirror support having a light-weight structure. The substrate includes recesses and is reinforced with covers in the region of bearing points for rigidification.

### CROSS REFERENCE TO RELATED APPLICATIONS

This application claims benefit under 35 U.S.C. §119(a) of German Patent Application No. 10-2009-005 400.6-51, filed Jan. 19, 2009, the entire contents of which are incorporated herein by reference.

### BACKGROUND OF THE INVENTION

1. Field of the Invention

The invention relates to a substrate made of glass or glass ceramic, which is designed, in particular, as a mirror support, as well as a method for its production. The invention further relates to an astronomical mirror, in particular for extraterrestrial applications.

2. Description of Related Art

Astronomical mirrors are known. What is involved in this case, in particular, are mirrors that are composed of a substrate made of glass ceramic.

The document JP 2004 185 811 A shows a mirror made of a material having a low thermal expansion, in which nearly the entire mirror structure is furnished with covers and in which the bearing points are formed by a crosspiece. The document WO 2006/034 775 A1 shows the production of a generic mirror substrate by grinding. The document EP 0 395 257 A2 shows a telescope mirror made of sintered ceramic. The document U.S. Pat. No. 7,080,915 B2 shows a telescope mirror substrate that is thinned by polishing in order to obtain the desired geometry. The document DE 196 26 364 C2 shows a mirror made of a composite material.

Because the geometry of astronomical mirrors of this type must have an extremely small deviation in shape with increasing size, astronomical mirrors are produced from, among other things, glass ceramics. What is involved in this case is generally a so-called zero-expansion material, that is, a material with a very low thermal expansion coefficient. In this way, it is assured that the geometry of the mirror hardly changes during variations in temperature. This plays a major role particularly in extraterrestrial applications in satellites, because, in this case, the materials are subjected to extreme variations in temperature.

Among other things, in order to reduce the changes in geometry that are produced on account of deflections due to dead weight, there are mirrors of this type that are made of a light-weight structure, in which the back side of the mirror comprises, for example, a honeycomb structure. A light-weight structure of this type is also of great importance for extraterrestrial applications. Here, above all, the costs of transport into outer space are paramount.

However, the application of the invention is not limited solely to astronomical mirrors. Mirror supports having extremely low shape deviation are also required in semiconductor technology for lithography devices.

By way of known substrates that comprise light-weight structures, it has already been possible to reduce substantially both the weight of a mirror support and to improve the rigidity of the mirror support and, in particular, to reduce deflections due to dead weight.

### BRIEF SUMMARY OF THE INVENTION

The invention is based on the problem of improving the known light-weight structures in comparison to the prior art described above.

In particular, the weight of a substrate, particularly that of a mirror support, is to be reduced and/or the rigidity of the substrate is to be increased.

The problem of the invention is solved by way of a substrate as well as a method for the production of a substrate as described herein.

The invention is related to a substrate made of glass or glass ceramic, which is designed, in particular, as a mirror support.

On one side, the back side, the substrate has recesses as well as at least one bearing point, preferably three bearing points. The recesses that are present form crosspieces on the back side of the substrate, which act as a light-weight structure. A bearing point in terms of the invention is understood to mean any region of the mirror to which a bearing can be fastened. The bearing points are designed as recesses having a cylindrical construction, preferably circular cylindrical construction.

The mirror is fastened to titanium mountings, for example, by means of these recesses.

According to the invention, the recesses in the region of the bearing point are provided with a cover, at least in sections.

A cover is understood to mean any arrangement that covers the top side of the recesses, at least partially. In particular, the recesses are essentially closed by means of covers. The recesses directly adjacent to the bearing point have a cover.

It has been found that, through the use of covers of this type, it has been possible to improve the rigidity of the substrate to a surprising degree.

At the same time, the weight of the covers, which are used only in a region surrounding the bearing points, is hardly of import in comparison to the rest of the mirror support. Thus, it is possible to design the remaining structure of the mirror support to be weaker, resulting in the achievement of a lower weight for the same rigidity.

It is conceivable to provide a single cover, which has an opening in the region of the bearing point and which covers a plurality of recesses adjacent to the bearing point.

In a preferred embodiment of the invention, however, a cover is provided for each recess. It has been found that, in this way, a greater shape precision can be achieved, because a large-area cover represents an additional risk for creating tensions in the substrate. Furthermore, the manufacture is simpler when individual covers are used.

In a preferred embodiment of the invention, adjacent covers are spaced from one another by a gap. As a result of this embodiment, it is also possible to reduce the danger of creating tensions due to the use of the cover.

The covers are preferably constructed from glass or glass ceramic, in particular from the same material as the rest of the substrate. In particular, the covers are also composed of a zero-expansion material, that is, a material having a very low thermal expansion coefficient.

In a preferred embodiment of the invention, the covers have essentially the shape of the respective recess. Hence, in the case of a triangular recess, a triangular cover is used and, in the case of a hexagonal recess, a hexagonal cover is used. Thus, the respective recess is essentially closed by the cover, resulting in an essentially equal distribution of tension in the material, regardless of the side from which a force acts on the substrate. However, it is also conceivable to close the recesses only partially, in particular, in order to provide a greater rigidity in the direction of preferred higher tensions.

In a preferred embodiment, the covers are adhesively attached. It has been found that an adhesive attachment of the covers ensures, on the one hand, a more secure attachment of the cover to the rest of the substrate and, on the other hand, makes possible relatively simple mounting. Preferably, a heat- and cold-stable glass adhesive is used as adhesive in this case. Alternatively, however, the covers can be attached to the rest of the substrate in a form-fitting or force-fitting manner; in particular, the covers could also be fastened by means of dowels or clamped.

In an enhancement of the invention, the substrate is furnished, at least on the back side, with a protective layer against ultraviolet radiation. Thus, particularly when adhesives are used in extraterrestrial applications, in which the UV radiation is extremely high, possible embrittlement of the adhesive due to the UV radiation is prevented.

In another preferred embodiment of the invention, the crosspieces that run between the recesses are undercut at the recesses provided with covers. In particular, the crosspieces have, as a result, an essentially T-shaped profile. Particularly in the case of glass ceramics, which can only be ground and, in consequence, have to be shaped by grinding, the undercutting requires a great manufacturing cost. Therefore, an undercut is usually dispensed with. In particular, when covers are adhesively attached, however, the undercut makes possible a broader front face of the respective crosspiece on which the cover is being placed and accordingly a better attachment.

In the case of the recesses that are not furnished with covers, an undercut is preferably dispensed with.

The substrate preferably consists of a zero-expansion material having a thermal expansion coefficient of less than 0.5×10⁻⁶ K⁻¹.

The recesses are preferably essentially triangular or of honeycomb shape in construction. As a rule, triangular recesses, particularly those consisting essentially of equilateral triangles, lead to the best possible rigidity. The introduction of triangular recesses of this type into a glass ceramic is associated with an extremely high processing cost, however. Preferably, therefore, essentially honeycomb-shaped, that is, hexagonally constructed recesses are used.

In a preferred embodiment of the invention, the recesses form an essentially regular arrangement; that is, they have essentially the same dimensions and are distributed uniformly, particularly in a honeycomb arrangement, over the back side of the substrate.

In another embodiment of the invention, the substrate is thinned, at least in sections, on the side furnished with the recesses, that is, the back side. The thinned region, at which the height of the substrate is also reduced on the back side, lies preferably between two bearing points.

In particular, the thinned region or thinned regions has/have its/their deepest point at about the site where a substrate that is not thinned and is borne on the bearing points has the greatest deflection. On account of the dead weight, a deflection results in the case of bearing at the bearing points and this can be reduced by thinnings of this kind. Furthermore, the requirements placed on the rigidity, particularly in the edge region of the substrate, are not as high, so that material can be dispensed with in this case.

By way of example, the thinnings can be calculated by means of a quadratic trial function for the removed material of the thinning, in which a local coordinate system is placed around the center of the thinning.

In order to compensate for the reduction in thickness, it is possible, as provided in an embodiment of the invention, to make the crosspiece widths between the recesses thicker in the thinned regions than in the rest of the substrate.

The substrate according to the invention is suitable, in particular, for large mirror substrates of greater than one meter.

In an enhancement of the invention, the bottom of the recesses in the substrate is convex in construction, in particular, essentially elliptical in cross section. By way of bottoms that are convex in construction, it is possible to increase further the rigidity of the substrate relative to its own weight.

In a preferred embodiment of the invention, the volume of the recesses takes up more than 50%, preferably more than 60%, of the volume of the total substrate. In this case, the volume of the recesses is also included in the volume of the substrate; that is, the volume of the substrate is calculated in such a manner as if all recesses were closed.

The substrate is preferably constructed of glass ceramic in one piece, with the exception of the covers.

In a preferred embodiment of the invention, the substrate has a thickness of between 100 and 250 mm, preferably of between 120 and 170 mm. In particular, in the case of mirrors of more than one diameter, the thickness of the substrate could be reduced to less than 200 mm for the same rigidity.

In a preferred embodiment of the invention, which is provided, in particular, for extraterrestrial applications, the shape of the substrate is calculated such that the substrate has no characteristic frequencies of less than 150 Hz. Otherwise, when a rocket is launched, low excitation frequencies of less than 150 Hz may result, which could destroy the substrate or the mirror that the substrate comprises.

The invention makes it possible to provide a mirror substrate in which the substrate borne on the bearing points (in the case of the force of gravity) has a deflection of less than 2 μm in any position.

The invention further relates to a mirror that comprises a substrate described above. In this case, the front side of the substrate, that is, the side that lies opposite to the side with the recesses, is mirrored. In particular, the mirror that is thus made available has an essentially rotationally symmetric shape; for example, the mirror is constructed as a parabolically shaped concave mirror.

The invention further relates to a satellite that comprises a mirror of this type.

The invention further relates to a method for the production of a substrate, in particular, a substrate described above.

In this case, a glass ceramic plate is provided. Thus, as a first step of manufacture, a glass substrate is ceramicized in order to then be further processed.

In this case, recesses and bearing points are introduced on the back side of the substrate. The bearing points may be constructed, for example, likewise as recesses. The recesses are introduced, as a rule, exclusively by grinding.

Covers are placed on the recesses adjacent to the bearing points.

The covers are preferably put in place as individual covers for each recess.

In accordance with the invention, the glass ceramic plate is thinned in sections on the back side prior to introduction of the recesses, so as, on the one hand, to reduce deflections due to dead weight and, on the other hand, to weaken the structure in the regions having less tension—for example, in the regions distant from the bearings.

In an enhancement of the invention, the crosspieces between the recesses on which the covers are being placed are undercut before the covers are put in place. The undercut is produced preferably by means of a grinding process.

The invention makes it possible to provide a light-weight structure of such a type that more than 80% of the material of the glass ceramic plate is removed.

### BRIEF DESCRIPTION OF THE SEVERAL VIEWS OF THE DRAWINGS

FIG. 1 is a schematic view of an exemplary embodiment of a substrate according to the present disclosure;

FIG. 2 is a cross section through an exemplary embodiment of an individual recess of the substrate of FIG. 1; and

FIG. 3 is cross sectional view of an exemplary embodiment of a crosspiece of the substrate of FIG. 1.

### DETAILED DESCRIPTION OF THE INVENTION

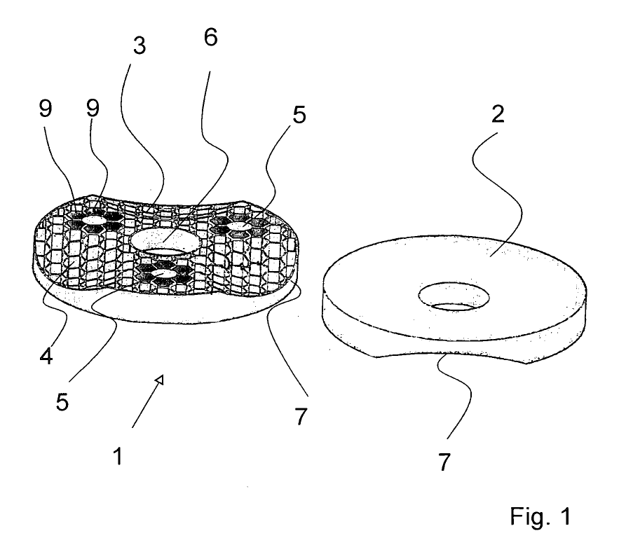

The invention will be described in more detail below with reference to the figures, FIG. 1 to FIG. 3.

FIG. 1 shows a schematic view of an embodiment example of a substrate 1, which is constructed as a mirror support for a concave mirror. To this end, substrate 1 comprises an essentially central opening 6. In this embodiment example, the substrate has a diameter of about 1.20 m.

The front side 2 of substrate 1 has a parabolic construction and is mirrored (not illustrated). On the back side 3, substrate 1 comprises a plurality of recesses 4, which are constructed in honeycomb shape and serve as a light-weight structure.

Furthermore, cylinder-shaped recesses are introduced on the back side as bearing points 5. In this embodiment example, substrate 1 is furnished with three bearing points 5.

For reinforcement of the structure in the region of bearing points 5, covers 9 are adhesively attached to the recesses.

Covers 9 are not completely closed, but rather provided with a perforation (not illustrated), so that any degassing that might occur during adhesive attachment can escape out of the cover and in order to not seal the honeycombs in an airtight manner.

The structure could be appreciably reinforced by way of the covers.

The substrate further comprises back-side thinnings 7 in order to reduce the deflection between bearing points 5 due to dead weight.

Thinnings 7 have their deepest point at the edge and becomes thicker in the direction of bearing points 5.

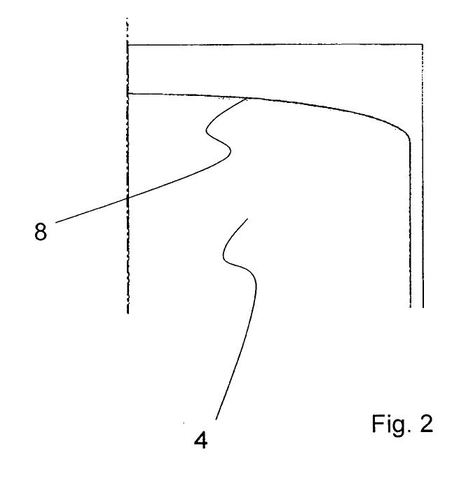

FIG. 2 shows a cross section through an individual recess 4. The bottom 8 of the recess is convex and, in this embodiment example, has an elliptical shape.

By way of the ellipse shape, it is possible to adapt the strength of recess 4 to various conditions.

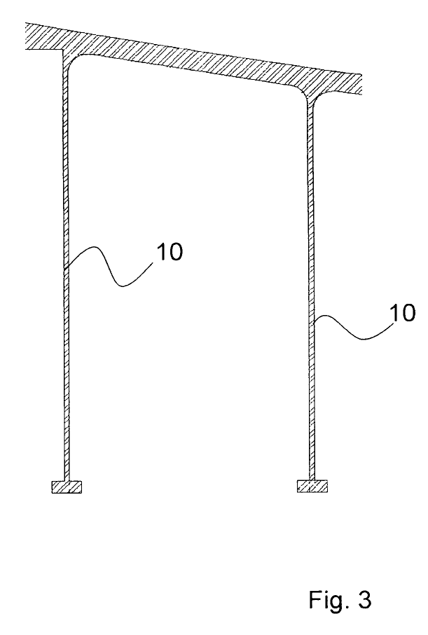

FIG. 3 shows a detailed view of a cut through one crosspiece 10, which is located between two recesses. Crosspiece 10 is undercut and has an essentially T-shaped cross section. Thus, the area can be increased for adhesive attachment of the covers (not illustrated).

It is obvious that the invention is not limited to one combination of the features described above, but rather the person skilled in the art will combine all of the illustrated features in any way, insofar as this is technically reasonable.

### LIST OF REFERENCE NUMBERS

1 Substrate
2 Front side
3 Back side
4 Recess
5 Bearing point
6 Opening
7 Thinning
8 Bottom
9 Cover
10 Crosspiece

What is claimed is:

1. A substrate made of glass or glass ceramic, comprising:
a first side having recesses and at least one bearing point, the at least one bearing point being a second recess, wherein the recesses are furnished with a cover only around the bearing point.

2. The substrate according to claim 1, wherein the substrate is a mirror support.

3. The substrate according to claim 1, further comprising a cover over the recesses immediately adjacent to the bearing point.

4. The substrate according to claim 3, wherein the cover has at least one perforation.

5. The substrate according to claim 1, further comprising an individual cover for each of the recesses.

6. The substrate according to claim 5, further comprising a gap between the individual cover of adjacent recesses.

7. The substrate according to claim 5, wherein the individual cover of each of the recesses comprises glass or glass ceramic.

8. The substrate according to claim 5, wherein the individual cover for each of the recesses comprises the same material as the rest of the substrate.

9. The substrate according to claim 5, wherein the individual cover for each of the recesses comprises a shape corresponding to the recess.

10. The substrate according to claim 5, further comprising an adhesive attaching the individual cover to the respective recess.

11. The substrate according to claim 5, further comprising crosspieces that run between the recesses, the crosspieces having an undercut for the individual cover.

12. The substrate according to claim 12, wherein the crosspieces have a T-shaped cross section.

13. The substrate according to claim 1, further comprising a second side having an ultraviolet radiation protective layer thereon.

14. The substrate according to claim 1, wherein the substrate has an expansion coefficient of less than 0.5×10⁻⁶ K⁻¹.

15. The substrate according to claim 1, wherein the recesses have a triangular shape or honeycomb shape.

16. The substrate according to claim 15, wherein the recesses have an essentially regular arrangement.

17. The substrate according to claim 1, further comprising a thinned region on the first side of the substrate.

18. The substrate according to claim 17, wherein the thinned region is arranged between two bearing points.

19. The substrate according to claim 17, wherein the thinned region comprises a first region thinned most deeply at a point at which a substrate that is not thinned and is borne on the bearing points has a greatest deflection.

20. The substrate according to claim 1, wherein the substrate has a diameter of greater than 1 m.

21. The substrate according to claim 1, wherein the recesses have a convex bottom region.

22. The substrate according to claim 1, wherein the recesses comprise a volume of more than 50% of a total volume of the substrate.

23. The substrate according to claim 1, wherein the recesses comprise a volume of more than 60% of a total volume of the substrate.

24. The substrate according to claim 1, wherein the substrate has a thickness of between 100 and 250 mm.

25. The substrate according to claim 1, wherein the substrate has a thickness of between 120 and 170 mm.

26. A mirror comprising:
a substrate having recesses and at least one bearing point on a first side, the at least one bearing point being a second recess, wherein the recesses are furnished with a cover only around the bearing point.

27. A method for the production of a substrate, comprising the steps:
providing a glass ceramic plate;
introducing recesses and bearing points onto the back side of the glass ceramic plate;
placing covers on recesses that are adjacent to the bearing points; and
thinning the substrate in sections between two bearing points on the side furnished with the recesses.
